(19) United States
(12) Patent Application Publication
(10) Pub. No.: US 2025/0357020 A1
(43) Pub. Date: Nov. 20, 2025

(54) Method for producing an electric cable with controlled cooling

(71) Applicant: NEXANS, Courbevoie (FR)

(72) Inventors: Antoine GASPARD, COURBEVOIE (FR); Gabriele PEREGO, MILAN (IT)

(21) Appl. No.: 18/702,999

(22) PCT Filed: Oct. 6, 2022
(86) PCT No.: PCT/FR2022/051895

§ 371 Date: Jul. 23, 2025

(30) Foreign Application Priority Data
Oct. 22, 2021 (FR) FR2111273

(51) Int. Cl. H01B 7/02; B29C 48/154; B29C 48/30; B29C 48/88; B29C 48/92; H01B 3/44; H01B 13/14; H01B 13/24

(52) U.S. Cl. CPC H01B 7/0275; B29C 48/154; B29C 48/30; B29C 48/911; B29C 48/92; H01B 3/441; H01B 13/14; H01B 13/24; B29C 2948/92704

(57) ABSTRACT

The invention relates to a method for producing a cable comprising at least one elongate electrically conductive element, a first semiconductor layer surrounding the elongate electrically conductive element, an electrically insulating thermoplastic layer surrounding the first semiconductor layer, and a second semiconductor layer surrounding the electrically insulating thermoplastic layer, the electrically insulating thermoplastic layer being obtained from an electrically insulating composition comprising at least one thermoplastic polymer (e.g. a propylene polymer), the method implementing controlled cooling of the cable after extrusion of the aforementioned layers.

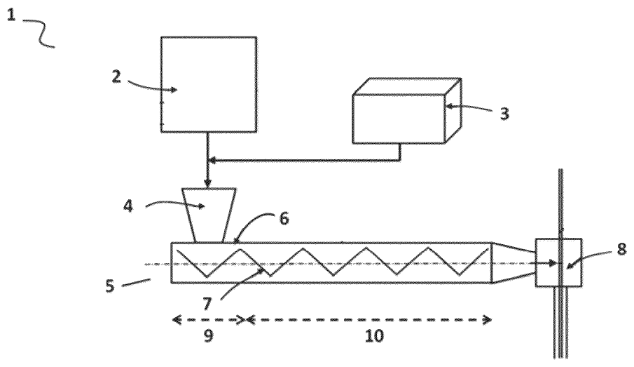

The invention relates to a method for manufacturing a cable comprising at least one elongate electrically-conducting element, a first semiconducting layer surrounding the elongate electrically-conducting element, an electrically-insulating thermoplastic layer surrounding the first semiconducting layer, and a second semiconducting layer surrounding the electrically-insulating thermoplastic layer, said electrically-insulating thermoplastic layer being obtained from an electrically-insulating composition containing at least one thermoplastic polymer (e.g. a propylene polymer), said method implementing controlled cooling of the cable following extrusion of the aforementioned layers.

The invention applies typically although not exclusively to the electric cables intended for transporting energy, notably the medium-voltage (notably from 6 to 45-60 kV) or high-voltage (notably in excess of 60 kV and potentially ranging up to 400 kV) either DC or AC power cables in the fields of overhead, underwater, or overland transmission of electrical power.

A medium-voltage or high-voltage power transporting cable preferably comprises, from the inside to the outside:
an elongate electrically-conducting element notably made of copper or of aluminum,
an inner semiconducting layer surrounding said elongate electrically-conducting element,
an electrically-insulating layer surrounding said inner semiconducting layer,
an outer semiconducting layer surrounding said electrically-insulating layer,
possibly an electrical shield surrounding said outer semiconducting layer, and
possibly an electrically-insulating protective sheath surrounding said electrical shield.

It is known practice to manufacture cables in which the electrically-insulating layer is a polymer layer based on crosslinked polyethylene (XLPE). The method thus comprises a step of extruding the polymer composition around the elongate electrically-conducting element, a step of crosslinking, and a step of cooling the cable by bringing the cable into contact with water at ambient temperature. The crosslinking encourages cohesion of the material of the layer during the cooling step.

Thermoplastic polymers such as polypropylene have also been tested as a replacement for XLPE, notably to promote the recycling of the raw materials and avoid the phenomenon known as “scorch phenomena” that may occur during crosslinking.

By way of example, international application WO02/47092 describes a method for manufacturing a cable comprising a step of using extrusion to apply an inner semiconducting layer, an electrically-insulating layer based on a propylene polymer, and an outer semiconducting layer, around an elongate electrically-conducting element, and a step of cooling the cable by passing the cable through a cooling duct containing a suitable liquid, such as water, maintained at a temperature of 12 to 15° C. The electrically-insulating layer thus obtained may exhibit morphological defects (microcavities, microcracks) that may lead to the onset of partial discharge and increase the risk of electrical breakdown.

It is therefore an object of the present invention to alleviate the disadvantages of the techniques of the prior art by proposing a method for manufacturing an electric cable, notably a medium-voltage or high-voltage cable, based on thermoplastic polymer(s) such as propylene polymer(s), said method being easy to implement, inexpensive, and leading to a thermoplastic layer that is uniform, i.e. that avoids the formation of morphological defects (microcavities, microcracks) within said thermoplastic layer.

This objective is achieved by the invention that will be described hereinafter.

The first subject of the invention is a method for manufacturing an electric cable comprising at least one elongate electrically-conducting element, an inner semiconducting layer surrounding the elongate electrically-conducting element, an electrically-insulating thermoplastic layer surrounding the inner semiconducting layer, and an outer semiconducting layer surrounding the electrically-insulating thermoplastic layer, said electrically-insulating thermoplastic layer containing at least one thermoplastic polymer, said method being characterized in that it comprises at least the following steps:
i) applying, by extrusion and in this order, the inner semiconducting layer, the electrically-insulating thermoplastic layer, and the outer semiconducting layer, around the elongate electrically-conducting element,
ii) cooling the outer semiconducting layer thus extruded in step i) by bringing it into contact with a first medium maintained at a temperature T₁ ranging from approximately 60 to 140° C. for sufficient time for the electrically-insulating thermoplastic layer to reach a temperature T-such that
Tc−25° C.≤T2 Tc+25° C. T_{c} being the crystallization temperature of the thermoplastic polymer, and
iii) cooling the cable thus obtained in step ii) by bringing it into contact with a second medium maintained at a temperature T₃ less than or equal to 50° C.

The method of the invention is simple to implement, inexpensive and does not require complex equipment. It makes it possible to obtain a cable that is able to operate at temperatures in excess of 70° C., just like XLPE-based cables. Moreover, it offers the advantages of using thermoplastic (i.e. recyclable) polymers and of leading to an electrically-insulating thermoplastic layer that is uniform, i.e. one in which the formation of morphological defects (microcavities, microcracks) is reduced or even avoided.

Specifically, during the manufacture of thermoplastic cables (i.e. cables comprising at least one electrically-insulating or non-crosslinked thermoplastic layer), and notably during the cooling step, the risk of the formation of morphological defects becomes great because of the absence of crosslinking, which crosslinking generally contributes to the cohesion of the layer. This risk is all the higher when the thermoplastic polymer or polymers used in the layer have a high melting point, which is the case for example with propylene polymer. Thus, with conventional cooling, the electrically-insulating thermoplastic layer begins to crystallize in the innermost zone close to the elongate electrically-conducting element and in the outermost zone close to the outer semiconducting layer because these zones lose heat more rapidly. This cooling therefore leads to an inner zone of the thermoplastic layer that is not crystallized and that is subjected to the physical forces of the zones that have already crystallized, encouraging the formation of morphological defects.

Thanks to the method of the invention and, in particular, thanks to the presence of steps ii) and iii), the electrically-insulating thermoplastic layer crystallizes starting from the inner zone, and the risk of the formation of morphological defects within this layer is reduced, if not to say avoided.

### Step i)

During step i), the three layers of the cable, i.e. the inner semiconducting layer, the electrically-insulating thermoplastic layer, and the outer semiconducting layer are applied by extrusion around the elongate electrically-conducting element.

The electrically-insulating thermoplastic layer is preferably obtained from an electrically-insulating composition containing at least the thermoplastic polymer material.

The inner semiconducting layer may be obtained from a first semiconducting composition.

The outer semiconducting layer may be obtained from a second semiconducting composition.

During this step i), the first semiconducting composition is extruded around the elongate electrically-conducting element to form the inner semiconducting layer; the electrically-insulating composition containing at least one thermoplastic polymer is extruded around the inner semiconducting layer to form the electrically-insulating thermoplastic layer; and the second semiconducting composition is extruded around the electrically-insulating thermoplastic layer to form the outer semiconducting layer.

Step i) may be performed using techniques well known to those skilled in the art, for example using an extruder.

During step i), the first and second semiconducting compositions and the electrically-insulating composition are in the molten state and pass preferably under pressure through a die, notably in the head of an extruder.

During step i), at least the electrically-insulating composition leaving the extruder is said to be “non-crosslinked”. The temperature and the time of residence in the extruder are optimized accordingly.

At the outlet from the extruder what is therefore obtained is a cable comprising at least one elongate electrically-conducting element, an extruded inner semiconducting layer surrounding the elongate electrically-conducting element, an extruded electrically-insulating thermoplastic layer surrounding the inner semiconducting layer, and an extruded outer semiconducting layer surrounding the electrically-insulating thermoplastic layer.

During the course of step i), the temperature within the extruder is preferably higher than the melting point of the majority polymer or of the polymer that has the highest melting point, from among the polymers used in the various compositions employed.

This step i) may be performed at an extrusion temperature T_{c} ranging from approximately 170° C. to approximately 240° C., and preferably ranging from approximately 180° C. to approximately 220° C.

According to a preferred embodiment of the invention, step i) comprises the following sub-steps:
i′) extruding a first semiconducting composition, it being possible for this first semiconducting composition to be crosslinked, around the elongate electrically-conducting element, i″) extruding the electrically-insulating composition containing at least one thermoplastic polymer around the inner semiconducting layer,
i′″) extruding a second semiconducting composition, it being possible for this second semiconducting composition to be crosslinked, around the electrically-insulating thermoplastic layer.

Sub-step i′) makes it possible to form the inner semiconducting layer surrounding said elongate electrically-conducting element.

Sub-step i″) makes it possible to form the electrically-insulating thermoplastic layer surrounding said inner semiconducting layer.

Sub-step i′″) makes it possible to form the outer semiconducting layer surrounding said electrically-insulating thermoplastic layer.

Sub-steps i′), i″), and i′″) are preferably concomitant, step i) then being a co-extrusion step.

Each of sub-steps i′), i″), and i′″) may be performed at an extrusion temperature T_{c} ranging from approximately 170° C. to approximately 240° C., and preferably ranging from approximately 180° C. to approximately 220° C.

### Step ii)

Step ii) enables the outer semiconducting layer thus extruded in step i) to be cooled in a controlled manner. Specifically, thanks to this step ii), progressive cooling of the cable from the inside toward the outside is performed.

In particular, this controlled cooling after extrusion step i) enables the outermost surface of the cable to be maintained at a temperature higher than the crystallization temperature of the thermoplastic polymer.

Thanks to this step ii), excessively rapid crystallization of the outer zones of the electrically-insulating thermoplastic layer (the zones close to the inner semiconducting layer and to the outer semiconducting layer) is avoided, and said step ii) enables the formation of morphological defects during cooling to be reduced if not to say avoided.

The temperature T₂ represents a temperature close to the crystallization temperature of the thermoplastic polymer.

During the contact in step ii) said outer semiconducting layer (and thus at least the outermost surface of the cable) may be cooled from the extrusion temperature T_{c} to a temperature T₄ greater than or equal to approximately 80° C.; and kept at a temperature T′₄ greater than or equal to approximately 80° C., it being possible for T′₄ to be greater than or equal to T₁, until the electrically-insulating thermoplastic layer reaches the temperature T₂ as defined in the invention.

The temperature T₄ is preferably greater than or equal to approximately 90° C., it being possible for T₄ to be greater than or equal to T₁ and more particularly preferably greater than or equal to approximately 100° C.

The temperature T′₄ is preferably greater than or equal to approximately 90° C., and particularly preferably greater than or equal to approximately 100° C.

The temperatures T₄ and T′₄ may be identical or different and are preferably identical.

In one preferred embodiment, step ii) is performed by bringing the outer semiconducting layer into contact with a cooling fluid (by way of first medium) selected from cooling liquids and cooling gases such as water, molecular nitrogen, a silicone oil, carbon dioxide, air, compressed air or ethylene glycol.

Water and molecular nitrogen are preferred by way of cooling fluids.

During step ii), the temperature T₁ preferably ranges from approximately 90 to 120° C.

In one particular embodiment of the invention, step ii) is performed at a cooling rate (for example to drop from the extrusion temperature T_{c} to the temperature T′₄) ranging from approximately 1 to 20° C. per minute, and preferably ranging from approximately 2 to 10° C. per minute.

The cooling rate can be achieved using a device for the thermostatic control of the cooling fluid.

Step ii) can be performed at a pressure ranging from approximately 1 to 15 bar and preferably ranging from approximately 5 to 12 bar.

The duration of step ii) is dependent on the diameter and structure of the cable.

Step ii) may last from approximately 1 min to approximately 1 hour, and preferably from approximately 20 min to approximately 45 minutes.

According to one preferred embodiment of the invention, the temperature T2 is such that

$$Tc - 25 °C . \leq T 2 Tc + 20 °C .$$

T_{c} being the crystallization temperature of the thermoplastic polymer, and it being possible for the temperature T₂ to be greater than or equal to T₁.

When the electrically-insulating composition contains several thermoplastic polymers, the temperature T_{c} corresponds to the crystallization temperature of the thermoplastic polymer that has the highest crystallization temperature or to the crystallization temperature of the blend of thermoplastic polymers.

In the present invention, the crystallization temperature T_{c} is determined by differential scanning calorimetry (DSC).

According to one particularly preferred embodiment of the invention, step ii) is performed by passing said cable of step i) through a cooling duct or tube containing said cooling fluid.

In particular, said cooling duct or tube is continuously supplied with said cooling fluid. Said fluid therefore circulates continuously in said cooling duct or tube.

The cooling duct or tube is preferably made of a metal such as, for example, steel.

According to another embodiment of the invention, step ii) is performed by passing said cable of step i) through one or more cooling tanks continuously supplied with the cooling fluid, notably so as to keep the temperature of the cooling tanks constant.

Each of the cooling tanks may contain a cooling fluid maintained at a temperature that differs according to the tank, the temperature decreasing from tank to tank, the temperature of the successive tanks for example being 90° C., 80° C. and 65° C.

Step iii)

Whereas step ii) represents a surface cooling, step iii) represents mass cooling.

In particular, as soon as the electrically-insulating thermoplastic layer reaches the temperature T₂ as defined in the invention, the cable can be cooled by bringing it into contact with a second medium maintained at a temperature less than or equal to 50° C.

In general, this step iii) allows the cable to be cooled down to ambient temperature (i.e. 18-30° C.). At the end of step iii), the cable thus obtained is ready to enter service and/or to be used in various applications.

In one preferred embodiment, step iii) is performed by bringing the cable of step ii) into contact with a cooling fluid (by way of second medium) selected from cooling liquids and cooling gases such as water, molecular nitrogen, a silicone oil, carbon dioxide, air, compressed air or ethylene glycol.

Water and molecular nitrogen are preferred by way of cooling fluids.

During step iii), the temperature T₃ preferably ranges from approximately 10 to 40° C.

According to one particularly preferred embodiment of the invention, step iii) is performed by passing said cable of step ii) through a cooling duct or tube containing said cooling fluid.

In particular, said cooling duct or tube is continuously supplied with said cooling fluid. Said fluid therefore circulates continuously in said cooling duct or tube.

The cooling duct or tube is preferably made of a metal such as, for example, steel.

### The Electrically-Insulating Composition

The thermoplastic polymer may have a crystallization temperature T_{c} ranging from approximately 100 to 140° C., and preferably from approximately 105 to 125° C.

The thermoplastic polymer may have a melting point T_{f} ranging from approximately 140 to 165° C., and preferably from approximately 145 to 165° C.

The thermoplastic polymer may be selected from propylene polymers.

According to one preferred embodiment of the invention, the thermoplastic polymer is a propylene polymer.

The thermoplastic polymer, or the thermoplastic polymers when there are several of these, preferably represents (represent) at least approximately 50 wt %, preferably approximately 60 to 95 wt %, and particularly preferably 100 wt %, with respect to the total weight of polymer(s) in the electrically-insulating composition.

The thermoplastic polymer may be a propylene homopolymer or copolymer P₁, and preferably a propylene copolymer P₁.

The propylene homopolymer P₁ preferably has an elastic modulus ranging from approximately 1250 to 1600 MPa.

In the present invention, the elastic modulus or Young's modulus (also known as “tensile modulus”) of a polymer is well known to a person skilled in the art and can be readily determined in accordance with ISO standard ISO 527-1, -2 (2012). Standard ISO 527 has a first part, denoted “ISO 527-1” and a second part, denoted “ISO 527-2” specifying the test conditions relating to the general principles of the first part of standard ISO 527.

The propylene homopolymer P₁ may represent at least 10 wt %, and preferably from 15 to 30 wt % with respect to the total weight of polymer(s) in the electrically-insulating composition.

By way of examples of propylene copolymers P₁, mention may be made of copolymers of propylene and of olefin, the olefin being notably selected from ethylene and an xi olefin other than propylene.

The ethylene or α₁ olefin other than propylene in the propylene-olefin copolymer preferably represents at most approximately 45 mol %, particularly preferably at most approximately 40 mol %, and more particularly preferably at most approximately 35 mol % with respect to the total number of moles of propylene-olefin copolymer.

The molar percentage of ethylene or of α₁ olefin in the propylene copolymer P₁ may be determined by nuclear magnetic resonance (NMR), for example according to the method described in Masson et al., Int. J. Polymer Analysis & Characterization, 1996, Vol. 2, 379-393.

The α₁ olefin other than propylene may correspond to the formula CH₂═CH—R¹, in which R¹ is a linear or branched alkyl group having 2 to 12 carbon atoms, notably selected from the following olefins: 1-butene, 1-pentene, 4-methyl-1-pentene, 1-hexene, 1-octene, 1-decene, 1-dodecene and a mixture thereof.

Propylene-ethylene copolymers are preferred by way of propylene copolymer P₁.

The propylene copolymer P₁ may be a homophasic propylene copolymer or a heterophasic propylene copolymer.

In the invention, the homophasic propylene copolymer P₁ preferably has an elastic modulus ranging from approximately 600 to 1200 MPa, and particularly preferably ranging from approximately 800 to 1100 MPa.

The homophasic propylene copolymer P₁ is advantageously a statistical propylene copolymer P₁.

The ethylene or the ai olefin other than propylene in the homophasic propylene copolymer P₁ preferably represents at most approximately 20 mol %, particularly preferably at most approximately 15 mol %, and more particularly preferably at most approximately 10 mol %, with respect to the total number of moles of the homophasic propylene copolymer P₁.

The ethylene or the α₁ olefin other than propylene in the homophasic propylene copolymer P₁ may represent at least approximately 1 mol % with respect to the total number of moles of homophasic propylene copolymer P₁.

By way of example of a statistical propylene copolymer P₁, mention may be made of that marketed by the Borealis company under the reference Bormed®RB 845 MO or that marketed by Total Petrochemicals under the reference PPR3221.

The heterophasic (or heterophase) propylene copolymer P₁ may contain a thermoplastic phase of the propylene type and a thermoplastic elastomer phase of the ethylene plus-olefin copolymer type.

The α₂ olefin of the thermoplastic elastomer phase of the heterophasic propylene copolymer P₁ may be propylene.

The thermoplastic elastomer phase of the heterophasic propylene copolymer P₁ may represent at least approximately 20 wt %, and preferably at least approximately 45 wt % with respect to the total weight of the heterophasic propylene copolymer P₁.

The heterophasic propylene copolymer P₁ preferably has an elastic modulus ranging from approximately 50 to 1200 MPa, and particularly preferably: either an elastic modulus ranging from approximately 0 to 550 MPa, and more particularly preferably ranging from approximately 50 to 300 MPa; or an elastic modulus ranging from approximately 600 to 1200 MPa, and more particularly preferably ranging from approximately 800 to 1200 MPa.

By way of example of a heterophasic propylene copolymer, mention may be made of the heterophasic propylene copolymer marketed by the LyondellBasell company under the reference Adflex® Q 200 F, or the heterophasic copolymer marketed by the LyondellBasell company under the reference Moplen EP®2967.

The propylene homopolymer or copolymer P₁ may have a melting point higher than approximately 110° C., preferably higher than approximately 130° C., and particularly preferably higher than approximately 135° C., and more particularly preferably ranging from approximately 140 to 170° C.

The propylene homopolymer or copolymer P₁ may have a crystallization temperature ranging from approximately 90 to 130° C., and preferably from approximately 100 to 120° C.

The propylene homopolymer or copolymer P₁ may have an enthalpy of fusion ranging from approximately 20 to approximately 100 J/g.

The propylene homopolymer P₁ preferably has an enthalpy of fusion ranging from approximately 80 to 90 J/g

The homophasic propylene copolymer P₁ preferably has an enthalpy of fusion ranging from approximately 40 to 90 J/g, and more particularly preferably ranging from 50 to 85 J/g.

The heterophasic propylene copolymer P₁ preferably has an enthalpy of fusion ranging from approximately 20 to 50 J/g.

The propylene homopolymer or copolymer P₁ may have a melt flow index ranging from 0.5 to 3 g/10 min; notably determined at approximately 230° C. under a load of approximately 2.16 kg in accordance with standard ASTM D1238-00 or standard ISO 1133.

The homophasic propylene copolymer P₁ preferably has a melt flow index ranging from 1.0 to 2.75 g/10 min, and more preferably ranging from 1.2 to 2.5 g/10 min; notably determined at approximately 230° C. under a load of approximately 2.16 kg in accordance with standard ASTM D1238-00 or standard ISO 1133.

The heterophasic propylene copolymer P₁ may have a melt flow index ranging from 0.5 to 3 g/10 min, and preferably ranging from approximately 0.6 to 1.2 g/10 min; notably determined at approximately 230° C. under a load of approximately 2.16 kg in accordance with standard ASTM D1238-00 or standard ISO 1133.

The propylene homopolymer or copolymer P₁ may have a density ranging from approximately 0.81 to 0.91 g/cm³; notably determined in accordance with standard ISO 1183A (at a temperature of 23° C.).

The propylene copolymer P₁ preferably has a density ranging from 0.85 to 0.91 g/cm³, and more particularly preferably ranging from 0.87 to 0.91 g/cm³; notably determined in accordance with standard ISO 1183A (at a temperature of 23° C.).

The electrically-insulating composition may contain several propylene polymers, particularly several different propylene copolymers P₁, notably two different propylene copolymers P₁, said propylene copolymers P₁ being as defined hereinabove.

In particular, the electrically-insulating composition may contain a homophasic propylene copolymer (by way of first propylene copolymer P₁) and a heterophasic propylene copolymer (by way of second propylene copolymer P₁), or two different heterophasic propylene copolymers.

When the electrically-insulating composition contains a homophasic propylene copolymer and a heterophasic propylene copolymer, said heterophasic propylene copolymer preferably has an elastic modulus ranging from approximately 50 to 300 MPa.

According to one embodiment of the invention, the two heterophasic propylene copolymers have different elastic modulus values. As a preference, the electrically-insulating composition contains a first heterophasic propylene copolymer with an elastic modulus ranging from approximately 50 to 550 MPa, and more particularly preferably ranging from approximately 50 to 300 MPa; and a second heterophasic propylene copolymer with an elastic modulus ranging from approximately 600 to 1200 MPa and more particularly preferably ranging from approximately 800 to 1200 MPa.

Advantageously, the first and second heterophasic propylene copolymers have a melt flow index as defined in the invention.

These combinations of propylene copolymers P₁ may advantageously make it possible to improve the physico-chemical and mechanical properties of the electrically-insulating layer.

According to one preferred embodiment of the invention, the propylene copolymer P₁ or the propylene copolymers P₁, when there are several of them, represents (represent) at least approximately 50 wt %, preferably from approximately 55 to 100 wt %, and more particularly preferably from approximately 60 to 85 wt %, with respect to the total weight of polymer(s) in the electrically-insulating composition.

The homophasic propylene copolymer P₁ may represent at least 20 wt %, and preferably from 25 to 70 wt % with respect to the total weight of polymer(s) in the electrically-insulating composition.

The heterophasic propylene copolymer P₁ or the heterophasic propylene copolymers P₁ when there are several of them, may represent from approximately 5 to 100 wt %, preferably from approximately 25 to 95 wt %, and more particularly preferably from approximately 60 to 80 wt %, with respect to the total weight of polymer(s) in the electrically-insulating composition.

The electrically-insulating composition may further contain an olefin homopolymer or copolymer P₂.

Said olefin homopolymer or copolymer Pe is preferably different than said propylene polymer or than said propylene homopolymer or copolymer P₁ (or than said propylene homopolymers or copolymers P₁).

The olefin of the olefin copolymer Pe may be selected from ethylene and an α₃ olefin corresponding to the formula CH₂═CH—R², where R² is a linear or branched alkyl group containing 1 to 12 carbon atoms.

The α₃ olefin is preferably selected from the following olefins: propylene, 1-butene, isobutylene, 1-pentene, 4-methyl-1-pentene, 1-hexene, 1-octene, 1-decene, 1-dodecene and a mixture thereof.

The α₃ olefin of the propylene, 1-hexene or 1-octene type is particularly preferred.

The combination of polymers P₁ and Pe makes it possible to obtain an electrically-insulating layer that offers good mechanical properties, notably in terms of elastic modulus, and good electrical properties.

The olefin homopolymer or copolymer P: is preferably an ethylene polymer.

The ethylene polymer preferably contains at least approximately 80 mol % of ethylene, particularly preferably at least approximately 90 mol % of ethylene, and more particularly preferably at least approximately 95 mol % of ethylene, with respect to the total number of moles of the ethylene polymer.

According to a preferred embodiment of the invention, the ethylene polymer is a low density polyethylene, a low-density linear polyethylene, a medium density polyethylene or a high-density polyethylene, and preferably a high-density polyethylene; notably in accordance with standard ISO 1183A (at a temperature of 23° C.). High-density polyethylene makes it possible to improve the thermal conductivity of the electrically-insulating layer.

The ethylene polymer preferably has an elastic modulus of at least 400 MPa and more particularly preferably of at least 500 MPa.

In the present invention, the expression “low-density” means having a density ranging from approximately 0.91 to 0.925 g/cm³, said density being measured in accordance with standard ISO 1183A (at a temperature of 23° C.).

In the present invention, the expression “medium-density” means having a density ranging from approximately 0.926 to 0.940 g/cm³, said density being measured in accordance with standard ISO 1183A (at a temperature of 23° C.).

In the present invention, the expression “high-density” means having a density ranging from 0.941 to 0.965 g/cm³, said density being measured in accordance with standard ISO 1183A (at a temperature of 23° C.).

According to one preferred embodiment of the invention, the olefin homopolymer or copolymer Pe represents approximately 5 to 50 wt %, and more particularly preferably from approximately 10 to 40 wt %, with respect to the total weight of polymer(s) in the electrically-insulating composition.

According to one particularly preferred embodiment of the invention, the electrically-insulating contains two propylene copolymers P₁ such as a homophasic propylene copolymer and a heterophasic propylene copolymer, or two different heterophasic propylene copolymers; and an olefin homopolymer or copolymer Pe such as an ethylene polymer. This combination of propylene copolymers P₁ and of an olefin homopolymer or copolymer Pe makes it possible to improve still further the mechanical properties of the electrically-insulating layer, while at the same time ensuring good thermal conductivity.

When the electrically-insulating composition contains several thermoplastic polymers, the combination of the thermoplastic polymers in the electrically-insulating composition preferably forms a thermoplastic polymer material.

Said thermoplastic polymer material is preferably heterophase (i.e. contains several phases). The presence of several phases generally stems from the mix of two different polyolefins, such as a mix of different propylene polymers or a mix of a propylene polymer and of an ethylene polymer.

In the invention, the “several thermoplastic polymers” may be several propylene polymers as defined in the invention, or a mix of a propylene polymer as defined in the invention, with other thermoplastic polymer(s) which are not necessarily propylene polymers.

The thermoplastic polymer material may represent at least approximately 50 wt %, preferably at least approximately 70 wt %, and particularly preferably at least approximately 80 wt %, with respect to the total weight of the electrically-insulating composition.

The electrically-insulating composition of the invention is a thermoplastic composition. It cannot therefore be crosslinked. In particular, the thermoplastic polymer material cannot be crosslinked.

In other words, the electrically-insulating composition preferably contains no crosslinking agents, or coupling agents of the silane or peroxide type, and/or no additives enabling crosslinking. Specifically, such agents degrade the propylene polymer(s) and, therefore, the thermoplastic polymer material.

The electrically-insulating composition is preferably recyclable.

The electrically-insulating composition may contain one or more additives.

The additives may be selected from agents encouraging workability, such as lubricants, compatibilizing agents, coupling agents, antioxidants, anti-UV agents, antioxidants, anti-water-treeing agents, pigments and mixtures thereof.

The antioxidants protect the electrically-insulating composition from the thermal stresses generated during the cable manufacturing steps or during the operation of the cable.

The antioxidants are preferably selected from crowded phenols, thioesters, sulfur-based antioxidants, phosphorus-based antioxidants, antioxidants of the amine type, and mixtures thereof.

By way of example of crowded phenols, mention may be made of 1,2-bis(3,5-di-tert-butyl-4-hydroxyhydrocinnamoyl) hydrazine (Irganox® MD 1024), pentaerythritol tetrakis(3-(3,5-di-tert-butyl-4-hydroxyphenyl)propionate) (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylene bis[3-(3,5-di-tert-butyl-4-hydroxyphenyl) propionate] (Irganox® 1035), tris(3,5-di-tert-butyl-4-hydroxybenzyl) isocyanurate (Irganox® 3114), 2,2′-oxamido-bis(ethyl-3 (3,5-di-tert-butyl-4-hydroxyphenyl) propionate) (Naugard XL-1) or 2,2′-methylenebis(6-tert-butyl-4-methylphenol).

By way of examples of sulfur-based antioxidants, mention may be made of thioethers such as didodecyl-3,3′-thiodipropionate (Irganox® PS800), distearyl thiodipropionate or dioctadecly-3,3′-thiodipropionate (Irganox® PS802), bis[2-methyl-4-{3-n-alkyl(C₁₂ or C₁₄)thiopropionyloxy}-5-tert-butylphenyl] sulfide, thiobis-[2-tert-butyl-5-methyl-4,1-phenylene] bis[3-(dodecylthio) propionate] or 4,6-bis(octylthiomethyl)-o-cresol (Irganox® 1520 or Irgastab® KV10).

By way of examples of phosphorus-based antioxidants, mention may be made of tris(2,4-di-tert-butyl-phenyl)phosphite (Irgafos® 168) or bis(2,4-di-tert-butylphenyl)pentaerythritol diphosphite (Ultranox® 626).

By way of examples of amine-type antioxidants, mention may be made of phenylene diamines (e.g. paraphenylene diamines such as 1PPD or 6PPD), styrene diphenyleneamines, diphenylamines, 4-(1-methyl-1-phenylethyl)-N-[4-(1-methyl-1-phenylethyl)phenyl]aniline (Naugard 445), mercapto benzimidazols, or polymerized 2,2,4-trimethyl-1,2-dihydroquinoline (TMQ).

By way of examples of antioxidant mixtures that can be used according to the invention, mention may be made of Irganox B225, which contains an equi-molar mixture of Irgafos 168 and of Irganox 1010 as described above.

The electrically-insulating composition may contain from approximately 0.01 to 5 wt %, and preferably from approximately 0.1 to 2 wt % of additives, with respect to the total weight of the electrically-insulating composition.

The electrically-insulating composition may further contain a dielectric liquid.

The dielectric liquid may contain at least one liquid selected from a mineral oil (e.g. napthenic oil, paraffin oil or aromatic oil), a vegetable oil (e.g. soya oil, linseed oil, rapeseed oil, corn oil or castor oil) a synthetic oil such as an aromatic hydrocarbon (alkylbenzene, alkylnaphthalene, alkylbiphenyl, alkyldiarylethylene, etc.), a silicone oil, an etheroxide, an organic ester and an aliphatic hydrocarbon, and preferably from a mineral oil (e.g. napthenic oil, paraffin oil or aromatic oil), a vegetable oil (e.g. soya oil, linseed oil, rapeseed oil, corn oil or castor oil) a synthetic oil such as an aromatic hydrocarbon (alkylbenzene, alkylnaphthalene, alkylbiphenyl, alkyldiarylethylene, etc.), a silicone oil and an aliphatic hydrocarbon.

The liquid that makes up the dielectric liquid (or, respectively, the dielectric liquid itself) is generally liquid at approximately 20-25° C.

The dielectric liquid may contain at least approximately 70 wt % of the liquid that makes up the dielectric liquid, preferably at least approximately 80 wt % and more particularly preferably at least approximately 90 wt % of the liquid that makes up the dielectric liquid, with respect to the total weight of the dielectric liquid.

Mineral oil is preferred by way of liquid contained in the dielectric liquid.

The dielectric liquid particularly preferably contains at least a mineral oil and at least a polar compound of the benzophenone or acetophenone type, or one of the derivatives thereof.

The mineral oil is preferably selected from naphthenic oils and paraffin oils.

The mineral oil is obtained from refining a crude petroleum oil.

According to one particularly preferred embodiment of the invention, the mineral oil contains a paraffinic carbon content (Cp) ranging from approximately 45 to 65at %, a naphthenic carbon content (Cn) ranging from approximately 35 to 55at % and an aromatic carbon content (Ca) ranging from approximately 0.5 to 10at %.

In one particular embodiment, the polar compound of benzophenone or acetophenone type, or one of the derivatives thereof, represents at least approximately 2.5 wt %, preferably at least approximately 3.5 wt %, and particularly preferably at least approximately 4 wt % with respect to the total weight of the dielectric liquid. The polar compound makes it possible to improve the dielectric strength of the electrically-insulating layer.

The dielectric liquid may contain at most approximately 20 wt % and preferably at most approximately 15 wt % of polar compound of benzophenone or acetophenone type, or one of the derivatives thereof, with respect to the total weight of the dielectric liquid. This maximum quantity makes it possible to guarantee modest, or even low (e.g. below approximately 10⁻³) dielectric losses and also to avoid migration of the dielectric liquid out of the electrically-insulating layer.

According to one preferred embodiment of the invention, the polar compound of benzophenone or acetophenone type, or one of the derivatives thereof, is selected from benzophenone, dibenzosuberone, fluoenone and anthrone. Benzophenone is particularly preferred.

The dielectric liquid may represent from approximately 1 wt % to 20 wt %, preferably from approximately 2 to 15 wt % and particularly preferably from approximately 3 to 12 wt % with respect to the total weight of the electrically-insulating composition.

### The First Semiconducting Composition

The first semiconducting composition may contain at least one thermoplastic polymer as defined in the invention and at least one electrically-conducting filler in sufficient quantity to render the inner semiconducting layer semiconducting.

As a preference, the first semiconducting composition contains at least approximately 6 wt % of electrically-conducting filler, preferably at least approximately 10 wt % of electrically-conducting filler, preferably at least approximately 15 wt % of electrically-conducting filler, and more preferably still, at least approximately 25 wt % of electrically-conducting filler, with respect to the total weight of the first semiconducting composition.

The first semiconducting composition may contain at most approximately 45 wt % of electrically-conducting filler, and preferably at most approximately 40 wt % of electrically-conducting filler with respect to the total weight of the first semiconducting composition.

The electrically-conducting filler may be carbon black.

### The Second Semiconducting Composition

The second semiconducting composition may contain at least one thermoplastic polymer as defined in the invention and at least one electrically-conducting filler in sufficient quantity to render the outer semiconducting layer semiconducting.

As a preference, the second semiconducting composition contains at least approximately 6 wt % of electrically-conducting filler, preferably at least approximately 10 wt % of electrically-conducting filler, preferably at least approximately 15 wt % of electrically-conducting filler, and more preferably still, at least approximately 25 wt % of electrically-conducting filler, with respect to the total weight of the second semiconducting composition.

The second semiconducting composition may contain at most approximately 45 wt % of electrically-conducting filler, and preferably at most approximately 40 wt % of electrically-conducting filler with respect to the total weight of the second semiconducting composition.

The electrically-conducting filler may be carbon black.

### Other Steps of the Method of the Invention

The method of the invention may further comprise a step i₀), prior to the step i) (i.e. prior to extrusion), of preparing the electrically-insulating composition.

What is obtained at the end of step i₀) is a homogenous electrically-insulating composition that can then be extruded around the inner semiconducting layer in accordance with step i) so as to obtain the electrically-insulating thermoplastic layer.

Step i₀) may involve: melting the thermoplastic polymer.

When the electrically-insulating composition contains several constituents, step i₀) may involve mixing the various constituents of the electrically-insulating composition, and melting the thermoplastic polymer.

Step i₀) is preferably performed at a temperature ranging from approximately 170° C. to 240° C., and particularly preferably from approximately 180° C. to 220° C.

Step i₀) is preferably performed using an extruder or an internal mixer, preferably an extruder.

According to one embodiment of the invention, the extruder performing step i₀) of the method of the invention is a single-screw extruder. It therefore comprises just one single screw.

The extruder may be equipped with at least one feed hopper connected to the extruder and configured to introduce or inject constituents of the electrically-insulating composition into the extruder.

According to one preferred embodiment of the invention, step i₀) comprises the following sub-steps:
i₀₁) a sub-step of introducing, notably at ambient temperature, the electrically-insulating composition containing said thermoplastic polymer into a first zone of the screw, referred to as the feed zone, and situated at the inlet end of the extruder, and
i₀₂) a sub-step during which the electrically-insulating composition of the sub-step i₀₁) is brought from the feed zone to one or more intermediate zones of the screw, enabling the electrically-insulating composition to be transported toward the extruder head situated at the outlet end of the extruder and allowing the thermoplastic polymer to be melted gradually.

The thermoplastic polymer of the electrically-insulating composition is preferably introduced into the extruder during sub-step i₀₁) in solid form, and particularly preferably in the form of granules.

Sub-step i₀₁) may be performed by means of a feed hopper.

When the electrically-insulating composition contains several polymers, all of the polymers of the electrically-insulating composition are preferably introduced during sub-step i₀₁) in solid form, and particularly preferably in the form of granules.

The sub-step i₀₁) may be performed at a pressure of at most 5 bar, preferably of at most 3 bar, and preferably of at most 1.5 bar. In a particularly preferred embodiment, the sub-step i₀₁) is performed at atmospheric pressure, namely at a pressure approximately equal to 1 bar.

Prior to the sub-step i₀₁) of introducing the thermoplastic polymer (or plurality of polymers) into the extruder, said thermoplastic polymer (or plurality of polymers) may be heated beforehand to a temperature ranging from 40° C. to 100° C.

The sub-step i₀₂) is then used to melt said thermoplastic polymer.

When the electrically-insulating composition contains several polymers, the sub-step i₀₂) allows the polymers to be mixed and melted.

During the sub-step i₀₂), the electrically-insulating composition is brought (continuously) from the feed zone to one or more intermediate zones of the screw, enabling the electrically-insulating composition to be transported toward the extruder head situated at the outlet end of the extruder and allowing the polymer(s) to be melted gradually.

The intermediate zones are situated between the feed zone and the extruder head.

The intermediate zones may comprise one or more heating zones, so as to control the temperature in the extruder.

The molten state (fusion) is achieved when the thermoplastic polymer (or plurality of polymers) is (or are) heated to a temperature above or equal to its (their) melting point.

The sub-step i₀₂) may be carried out at a temperature ranging from approximately 170° C. to 240° C., and particularly preferably from approximately 180° C. to 220° C.

The sub-step i₀₂) may be performed at a pressure ranging from 1 to 300 bar.

According to one particularly preferred embodiment of the invention, the extruder comprises a barrier screw and/or a grooved barrel. The use of a specific type of barrel (i.e. grooved barrel) and/or of a specific type of screw (i.e. barrier screw) makes it possible to obtain a homogenous electrically-insulating composition that is easy to extrude, while at the same time avoiding or limiting the formation of structural defects in the electrically-insulating layer obtained.

When step i₀) is performed by means of an extruder, the following step i) consists in recovering the electrically-insulating composition formed in one or more intermediate zones of the extruder and brought to the extruder head in order to apply it around the inner semiconducting layer.

The method of the invention preferably comprises no step of crosslinking the electrically-insulating layer obtained in step i). Specifically, thermoplastic polymers such as propylene polymers degrade under the action of crosslinking and/or in the presence of crosslinking agents such as peroxides.

When the electrically-insulating composition contains one or more additives and/or a dielectric liquid, these may be introduced into the extruder during sub-step i₀₁).

The dielectric liquid and/or the additives, and the thermoplastic polymer may be brought into contact in the feed hopper or in the extruder, notably in the feed zone; and preferably in the feed hopper.

The dielectric liquid and/or additives and the thermoplastic polymer may be brought into contact at a temperature ranging from approximately 15° C. to 80° C., and preferably at ambient temperature.

In the present invention, the expression “ambient temperature” means a temperature varying from approximately 15 to 35° C., and preferably varying from approximately 20 to 25° C.

Said dielectric liquid and/or additives and the thermoplastic polymer are preferably brought into contact at a pressure of at most 5 bar, preferably of at most 3 bar, and preferably of at most 1.5 bar. In one particularly preferred embodiment, contact is performed at atmospheric pressure, namely at a pressure approximately equal to 1 bar.

The sub-step i₀₁) enables the dielectric liquid and/or one or more additives to be brought into contact with the thermoplastic polymer.

According to a first variant of the method of the invention, the sub-step i₀₁) or the bringing of said dielectric liquid and/or additives and the thermoplastic polymer into contact comprises no step of impregnating the thermoplastic polymer with the dielectric liquid. In other words, the dielectric liquid is not fully absorbed by the thermoplastic polymer, notably prior to the melting of the thermoplastic polymer in sub-step i₀₂). Specifically, a conventional impregnation step may be lengthy and require a minimal quantity of dielectric liquid (approximately 10-15% with respect to the total mass of the electrically-insulating composition).

In a second variant of the method of the invention, contact comprises a step of impregnating the thermoplastic polymer with the dielectric liquid. In that case, prior to the introduction of the electrically-insulating composition containing said thermoplastic polymer into a first zone of the screw, there takes place a sub-step of impregnating the thermoplastic polymer with the dielectric liquid in order to form an impregnated thermoplastic polymer or an impregnated thermoplastic polymer material which is then introduced into said first zone.

### The Electrically-Insulating Thermoplastic Layer

The electrically-insulating thermoplastic layer of the cable of the invention is a non-crosslinked layer.

In the invention, the expression “non-crosslinked layer” or “thermoplastic layer” means a layer in which the gel content in accordance with standard ASTM D2765-01 (extraction with xylene) is at most approximately 30%, preferably at most approximately 20%, particularly preferably at most approximately 10%, more particularly preferably at most 5%, and even more particularly preferably still, 0%.

In one particular embodiment, the electrically-insulating thermoplastic layer has a tensile strength (RT) of at least 8.5 MPa, preferably of at least approximately 10 MPa, and particularly preferably of at least approximately 12 MPa prior to ageing (in accordance with standard CEI 20-86).

In one particular embodiment, the electrically-insulating thermoplastic layer has an elongation at break (ER) of at least approximately 250%, preferably least of at approximately 300%, and particularly preferably of at least approximately 350% prior to ageing (in accordance with standard CEI 20-86).

In one particular embodiment, the electrically-insulating thermoplastic layer has a tensile strength (RT) of at least 8.5 MPa, preferably of at least approximately 10 MPa, and particularly preferably of at least approximately 12 MPa after ageing (in accordance with standard CEI 20-86).

In one particular embodiment, the electrically-insulating thermoplastic layer has an elongation at break (ER) of at least approximately 250%, preferably of at least approximately 300%, and particularly preferably of at least approximately 350% after ageing (in accordance with standard CEI 20-86).

The tensile strength (RT) and the elongation at break (ER) (prior to or after ageing) may be measured in accordance with standard NF EN 60811-1-1, notably with apparatus marketed by Instron under the reference 3345.

Ageing is generally performed at 135° C. for 240 hours (or 10 days).

The electrically-insulating thermoplastic layer of the cable of the invention is preferably a recyclable layer.

The electrically-insulating thermoplastic layer of the invention is an extruded layer.

The electrically-insulating thermoplastic layer of the invention may contain at least the thermoplastic polymer, possibly one or more additives, and a dielectric liquid, the aforementioned ingredients being as defined in the invention.

The proportions of the various ingredients in the electrically-insulating thermoplastic layer may be identical to those as described in the invention for these same ingredients in the electrically-insulating composition.

The electrically-insulating thermoplastic layer has a thickness that can vary according to the type of cable envisioned. The thickness is notably dependent on the size of the elongate electrically-conducting element.

The electrically-insulating layer of the invention preferably has a thickness of at least approximately 4 mm, more particularly preferably ranging from approximately 5 to 50 mm, and more particularly preferably ranging from approximately 6 to 30 mm. With such thicknesses, it is all the more important to ensure uniform cooling of the cable at the end of extrusion in order to avoid the appearance of morphological defects.

In the present invention, what is meant by an “electrically-insulating layer” is a layer the electrical conductivity of which may be at most 1×10⁻⁸ S/m (siemens per meter), preferably at most 1×10⁻⁹ S/m, and particularly preferably at most 1×10⁻¹⁰ S/m, measured at approximately 25° C. using direct current.

In the present invention, what is meant by a “semiconducting layer” is a layer the electrical conductivity of which may be strictly greater than 1×10⁻⁸ S/m (siemens per meter), preferably at least 1×10⁻³ S/m, and preferably may be less than 1×10³ S/m, measured at 25° C. using direct current.

### The Cable

The cable of the invention relates more particularly to the field of electric cables operating using direct current (DC) or alternating current (AC).

The elongate electrically-conducting element is preferably positioned at the center of the cable.

The elongate electrically-conducting element may be a one-piece conductor such as, for example, a metal wire or a multi-piece conductor such as a plurality of metal wires that may or may not be twisted together.

The elongate electrically-conducting element may be made of aluminum, of aluminum alloy, of copper, of copper alloy, or of a combination thereof.

The electrically-insulating layer more particularly has an electrical conductivity lower than that of the semiconducting layer. More specifically, the electrical conductivity of the semiconducting layer may be a factor of at least 10 times greater than the electrical conductivity of the electrically-insulating layer, preferably at least 100 times greater than the electrical conductivity of the electrically-insulating layer, and particularly preferably at least 1000 times greater than the electrical conductivity of the electrically-insulating layer.

In one particular embodiment, the inner semiconducting layer, the electrically-insulating layer and the outer semiconducting layer constitute a three-layer insulating. In other words, the electrically-insulating layer is in direct physical the inner semiconducting layer, and the outer semiconducting layer is in direct physical contact with the electrically-insulating layer.

The inner semiconducting layer (and respectively the outer semiconducting layer) is preferably a thermoplastic layer or a non-crosslinked layer.

The cable may further comprise a protective external sheath surrounding the electrically-insulating layer (or the outer semiconducting layer).

The protective external sheath may be in direct physical contact with the electrically-insulating layer (or the outer semiconducting layer).

The protective external sheath may be an electrically-insulating sheath.

The electric cable may further comprise electric shielding (e.g. made of metal) surrounding the outer semiconducting layer. In that case, the electrically-insulating sheath surrounds said electrical shielding and the electrical shielding is positioned between the electrically-insulating sheath and the outer semiconducting layer.

This metal shielding may be “braided” shielding made up of a collection of copper or aluminum conductors arranged around and along the outer semiconducting layer, “foil” shielding made up of one or more conducting metal foils made of copper or of aluminum and wrapped, possibly in a helix, around the outer semiconducting layer or a metal conductive foil made of aluminum and wrapped longitudinally around the outer semiconducting layer and rendered fluidtight using adhesive bonding in the zones of overlap of parts of said foil, or “water-impervious” shielding of the metal tube type possibly composed of lead or lead alloy and surrounding the outer semiconducting layer. This last type of shielding notably provides a barrier to moisture that might tend to penetrate the electric cable in a radial direction.

The metal shielding of the electric cable of the invention may comprise “braided” shielding and “water-impervious” shielding, or “braided” shielding and “foil” shielding.

All the types of metal shielding may act as a ground-bonding of the electric cable and may thus transport fault currents, for example in the event of a short-circuit in the network concerned.

Other layers, such as layers that swell in the presence of moisture, may be added between the second semiconducting layer and the metal shielding, these layers providing the electric cable with longitudinal watertightness.

### BRIEF DESCRIPTION OF THE DRAWINGS

The sole FIGURE depicts a device for implementing a method according to the invention.

For the sake of clarity, only those elements essential to understanding the invention have been depicted, schematically, and not to scale.

In the sole FIGURE the device 1 comprises a container 2 that can be fed with granules of a thermoplastic polymer such as a propylene polymer, a container 3 that can be fed with a dielectric liquid, a feed hopper 4 that can be fed at ambient temperature with the thermoplastic polymer granules contained in the container 2 and with the dielectric liquid contained in the container 3, and an extruder 5 comprising a grooved barrel 6 and/or a barrier screw 7, as well as an extruder head 8. The thermoplastic polymer granules and the dielectric liquid are introduced via the feed hopper 4 into a feed zone 9 of the screw according to step i₀), then conveyed from the feed zone 9 to one or more intermediate zones 10, enabling the electrically-insulating composition to be transported toward the extruder head 8 situated at the outlet end of the extruder 5 and allowing the thermoplastic polymer to be melted gradually, said intermediate zones 10 being situated between the feed zone 9 and the extruder head 8. Finally, at the extruder head 8, the electrically-insulating composition is applied around the inner semiconducting layer. Immediately after extrusion, the cable is conveyed to a gradual-cooling device.

1. A method for manufacturing an electric cable having
at least one elongate electrically-conducting element,
an inner semiconducting layer surrounding the elongate electrically-conducting element,
an electrically-insulating thermoplastic layer surrounding the inner semiconducting layer, and
an outer semiconducting layer surrounding the electrically-insulating thermoplastic layer, said electrically-insulating thermoplastic layer containing at least one thermoplastic polymer,
said method comprising at least the following steps:
i) applying, by extrusion and in this order, the inner semiconducting layer, the electrically-insulating thermoplastic layer, and the outer semiconducting layer, around the elongate electrically-conducting element,
ii) cooling the outer semiconducting layer thus extruded in step i) by bringing it into contact with a first medium maintained at a temperature T₁ ranging from approximately 60 to 140° C. for sufficient time for the electrically-insulating thermoplastic layer to reach a temperature T₂ such that
$$Tc - 25 °C . \leq T 2 Tc + 25 °C . ,$$
T_{c} being the crystallization temperature of the thermoplastic polymer, and
iii) cooling the cable thus obtained in step ii) by bringing it into contact with a second medium maintained at a temperature T₃ less than or equal to 50° C.

2. The method as claimed in claim 1, wherein step i) is carried out at an extrusion temperature T_{c} ranging from 170° C. to 240° C.

3. The method as claimed in claim 1, wherein the thermoplastic polymer is a propylene polymer.

4. The method as claimed in claim 1, wherein the thermoplastic polymer represents at least approximately 50 wt %, with respect to the total weight of polymer(s) in the electrically-insulating composition.

5. The method as claimed in claim 1, wherein the temperature T₁ of step ii) ranges from 90 to 120° C.

6. The method as claimed in claim 1, wherein step ii) is performed at a cooling rate ranging from 1 to 20° C. per minute.

7. The method as claimed in claim 1, wherein step ii) is performed at a pressure ranging from 1 to 15 bar.

8. The method as claimed in claim 1, wherein the temperature T₂ of step ii) is such that
$$Tc - 25 °C . \leq T 2 Tc + 20 °C . ,$$
T_{c} being the crystallization temperature of the thermoplastic polymer.

9. The method as claimed in claim 1, wherein step ii) is performed by bringing the outer semiconducting layer into contact with a cooling fluid selected from cooling liquids and cooling gases such as water, molecular nitrogen, a silicone oil, carbon dioxide, air, compressed air or ethylene glycol.

10. The method as claimed in claim 1, wherein step ii) is performed:
by passing said cable of step i) through a cooling duct or tube continuously supplied with a cooling fluid, or
by passing said cable of step i) through one or more cooling tanks continuously supplied with a cooling fluid.

11. The method as claimed in claim 2, wherein during the contact of step ii), said outer semiconducting layer is cooled from the extrusion temperature T_{c} to a temperature T₄ greater than or equal to 80° C.; and kept at a temperature T′₄ greater than or equal to 80° C., until the electrically-insulating thermoplastic layer reaches the temperature T₂.

12. The method as claimed in claim 1, wherein said method further comprises a step i₀), prior to the step i), of preparing the electrically-isolating composition using a single-screw extruder, the step i₀) comprising the following sub-steps:
i₀₁) a sub-step of introducing the electrically-insulating composition containing said thermoplastic polymer into a first zone of the screw, referred to as the feed zone, and situated at the inlet end of the extruder,
i₀₂) a sub-step during which the electrically-insulating composition of the sub-step i₀₁) is brought from the feed zone to one or more intermediate zones of the screw, enabling the electrically-insulating composition to be transported toward the extruder head situated at the outlet end of the extruder and allowing the thermoplastic polymer to be melted gradually.

13. The method as claimed in claim 1, wherein the electrically-insulating layer is a non-crosslinked layer.

14. The method as claimed in claim 1, wherein the thermoplastic polymer has a melting point T_{f} ranging from 140 to 165° C.

15. The method as claimed in claim 1, wherein the thermoplastic polymer has a crystallization temperature T_{c} ranging from 100 to 140° C.
